(19) United States
(12) Patent Application Publication
(10) Pub. No.: US 2011/0273551 A1
(43) Pub. Date: Nov. 10, 2011

(54) METHOD TO CONTROL MEDIA WITH FACE DETECTION AND HOT SPOT MOTION

(75) Inventors: Ruiduo Yang, Burbank, CA (US); Ying Luo, Stevenson Ranch, CA (US); Tao Zhang, Plainsboro, NJ (US)

(73) Assignee: THOMSON LICENSING

(21) Appl. No.: 13/138,190

(22) PCT Filed: Jan. 21, 2009
(86) PCT No.: PCT/US2009/000348

§ 371 Date: Jul. 18, 2011

(51) Int. Cl. G06K 9/00; H04N 5/225

(52) U.S. Cl. 348/77; 382/103; 348/E05.024

(57) ABSTRACT

The invention relates to a robust method to control interactive media using gestures. A method of controlling a multimedia device, using face detection and (hot spot) motion, providing robust accuracy in issued commands, wherein the method involves the following steps: extracting a hot spot area using a current captured image (Ci), calculate and analyze the difference between the current captured image (Ci) and a previous captured image (Ci−1), resulting in Di, applying an erosion on the Di to remove small areas, applying extracted (hot spot) motion areas as masks to filter out non-hot spot area motion, add Di to build a motion image, find the largest x, y and the smallest x, y coordinates of all the detected motion connected components, denote each as Ix, Iy, sx and sy, and perform an algorithm to determine if a hand gesture represents a command to control a multimedia device.

### FIELD OF THE INVENTION

The invention relates to a method of controlling a multimedia outlet device, in particular, the invention relates to a method to control a multimedia outlet device with face detection and hot spot motion.

### BACKGROUND OF THE INVENTION

Operating electronic devices has become increasingly reliant on the electronic remote control, which permits a user to issue commands from a distance. Generally, remote controls are self-powered and issue commands via infrared (IR) and radio signals.

In a typical home, one or more electronic devices, such as a television or video projection system, a satellite or cable TV receiver, a CD player, a video recorder, a DVD player, an audio tuner, computer systems and even lighting, can be controlled using remote controls. Although these remotes have become very complex, the use of remote controls has become evermore popular. Many electronic consumers have a stronger desire to increase interactivity with all forms of multimedia, especially the television.

Electronic consumers have long desired increased interaction and participation with media without an electronic remote, specifically through gestures of the human body. Hand movements would prove worthy to command and interact with media outlets.

Gesture recognition technology allows users to interact with electronic devices without the use of other mechanical devices, such as an electronic remote control. This technology usually includes a camera that reads the movements of the human body and communicates the data collected from the camera to a computer. The computer then recognizes a selected gesture as an intended command for the electronic device. For instance, in practice, the user can point a finger at a television or computer screen in order to move a cursor or activate an application command.

An interactive media system is disclosed in U.S. Pat. No. 7,283,983, which teaches a computer coupled to a video camera to provide a method for utilizing imaging and recognition techniques to provide augmented interaction for a human user in conjunction with use of printed media such as books, educational materials, magazines, posters, charts, maps, individual pages, packaging, game cards etc. The computer system uses a vision-based sensor to identify printed media and retrieve information corresponding to that view. The sensor then identifies a first user gesture relative to, at least, a portion of the media. The computer system then interprets the gesture as a command, and based at least in part on the first gesture and the retrieved information, the system electronically speaks aloud at least a portion of the retrieved information.

Human gestures can originate from any bodily motion or state, including the hand movement described above. Facial recognition can further assist a motion detection system by distinguishing where those gestures come from, and filtering out non-relevant movement.

Although humans have the innate ability to recognize and distinguish between faces, it has been quite difficult to employ that same intrinsic capability into computer software. However, in the past few years, the systems have become better developed.

Facial recognition, used with computer systems, permits the identification and verification of a person from a digital image or video source. Since the human face has numerous, distinguishable characteristics, comparison of these characteristics may be utilized for identification of a person. Using algorithms, computer software can compare characteristics, such as the distance between the eyes, depth of eye sockets, shape of cheekbones, as well as many other facial features, and then compare each feature with existing facial data.

U.S. Pat. No. 6,377,995, issued to Agraham et al., provides a method and apparatus for indexing multi-media communication using facial and speech recognition, so that selected portions of the multi-media communications can be efficiently retrieved and replayed. The method and apparatus combine face and voice recognition to identify participants to a multicast, multimedia conference call, which can include data or metadata. A server determines an identity of a particular participant when both the audio and video face patterns match speech and face models for particular participants, and then creates an index of participants based on identification of speech and face patterns of the participants, whereby the index is used to segment the multimedia communication.

Depth-awareness cameras are widely available and used to control media, as well. Video pattern recognition software, such as the Sony Eyetoy and Playstation Eye, utilize specialized cameras to generate a depth map of what is being seen through the camera at a short range, allowing a user to interact with media using motion, color detection and even sound, using a built-in microphone.

U.S. Pat. No. 6,904,408 issued to McCarty et al. teaches a web content manager used to customize a user's web browsing experience. The manager selects appropriate on-line media according to a user's psychological preferences, as collected in a legacy database and responsive to at least one real-time observable behavioral signal. Skin temperatures, pulse rate, heart rate, respiration rate, EMG, EEG, voice stress and gesture recognition are some of the behavioral responses and psychological indicators are measured and analyzed. Gesture recognition is accomplished by computer analyses of video inputs. The position of the face may indicate an upbeat or downbeat attitude, where the count of blinks per minute may be used for indicating anxiety.

Gesture recognition has proven advantageous for many applications. However, gesture recognition has many challenges, including robustness and accuracy of the gesture recognition software. For image-based gesture recognition there are limitations associated with the equipment and the amount of noise found in the field of view. Unintended gestures and background movement hamper full recognition of issued commands.

### SUMMARY OF THE INVENTION

The invention provides a robust method to control interactive media using gestures. A method to control media with face detection and hot spot motion, providing robust accuracy in issued commands, wherein the method involves the following steps: extracting a motion area using a current captured image (Cᵢ), calculate and analyze the difference between the current captured image (Cᵢ) and a previous captured image (Cᵢ₋₁), resulting in Dᵢ, applying an erosion on the Dᵢ to remove small areas, applying to extracted hot spot areas a mask to filter out non-motion areas, add D1 to build a motion history image, find the largest x, y and the smallest x, y coordinates of all the detected motion connected components, denote each as lx, ly, sx and sy, and perform an algorithm to determine if a hand gesture is command to the control the media.

The invention further relates to a media control apparatus having a media control apparatus having a camera having an image sensor and an input image module that receives picture images through the image sensor. The input image module further connects to a face detection module and a gesture recognition module, through the memory. A media control interface receives commands from the input image module and issues electrical signals to a multimedia outlet device.

### BRIEF DESCRIPTION OF THE DRAWINGS

The invention will be explained in greater detail in the following with reference to embodiments, referring to the appended drawings, in which:

FIG. 1 is a block diagram of a representative equipment used by a multimedia control system;

FIG. 2 is a perspective view of the multimedia control system;

FIG. 3 is flow diagram of the face detection module;

FIG. 4 is an illustrative representation of the face detection module processing a current captured image using the face detection algorithm;

FIG. 5 is flow diagram of the gesture recognition module;

FIG. 6 is an illustrative representation of the gesture recognition module processing a current captured image using the gesture recognition algorithm.

### DETAILED DESCRIPTION OF THE INVENTION

The invention will now be described in greater detail wherein embodiments of the present invention are illustrated in the accompanying drawings.

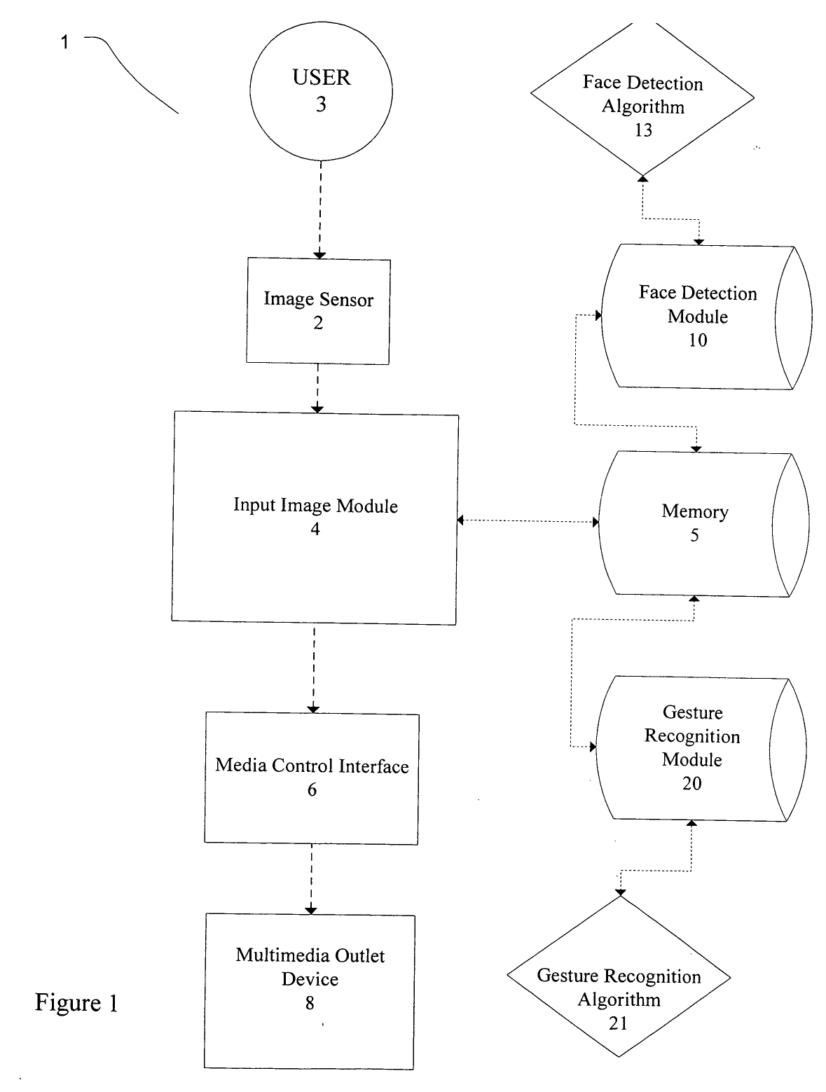

Referring now to FIG. 1, a multimedia control system 1 according the present invention is illustrated. The multi-media control system 1 comprises an image sensor 2, an input image module 4 connected to a memory 5, a media control interface 6, a face detection module 10 and a gesture recognition module 20 connected to the memory 5, and a multimedia outlet device 8.

The image sensor 2, in particular, is a device that converts an optical image to an electrical signal. The electrical signal is input to the image module 4 and is stored into the memory 5 prior to processing.

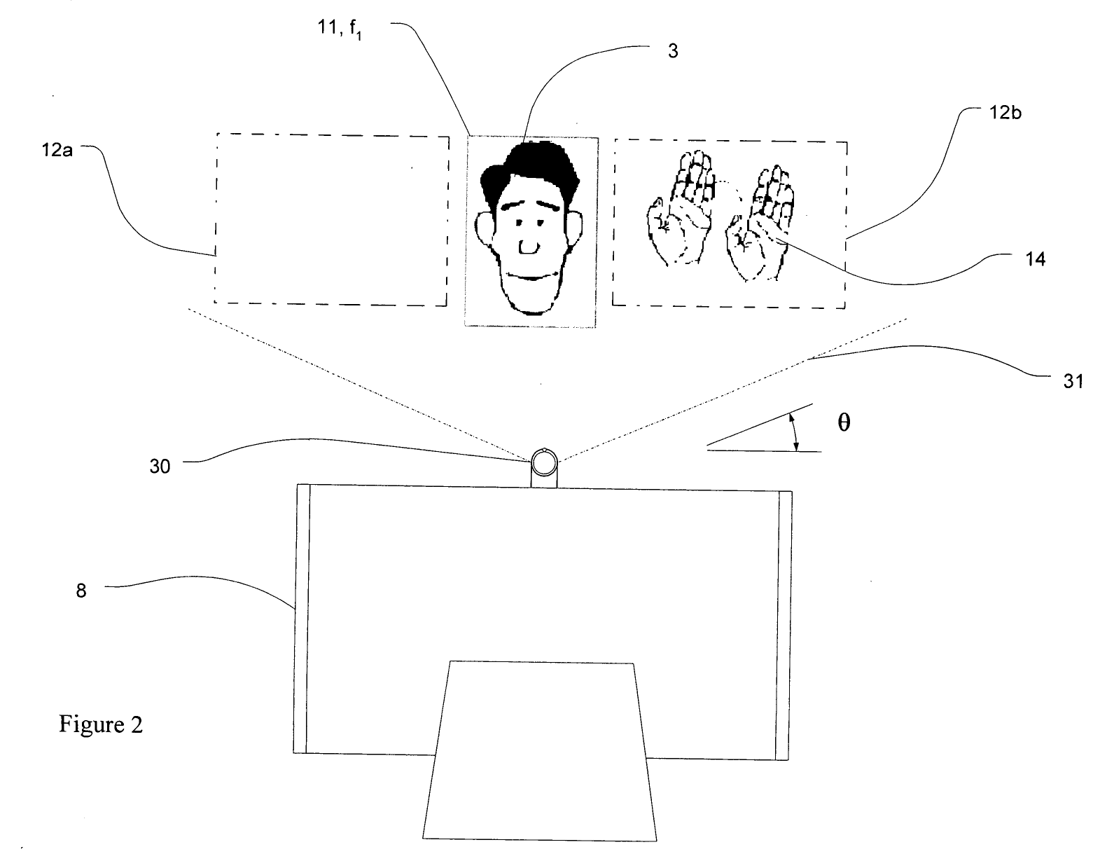

Fundamentally, the image sensor 2 is used in conjunction with a digital camera 30, as further illustrated in FIG. 2. The camera 30 is used to capture and focus light on the image sensor 2. The image sensor 2 captures a plurality of still images from a multimedia user 3, who may or may not issue commands to the multimedia outlet device 8. The image sensor 2 accomplishes the task of converting captured light into electrical output signals, which are processed through the input image module 4. The face detection and gesture recognition modules 10, 20 are connected to the input image module 4 through the memory 5, and process the electrical signals, in conjunction determining if an issued command has been performed by the user 3.

The camera 30 may have a zoom lens (not shown), which can adjust the camera's field of view, by an angle θ. This is the first and most fundamental way to limit potential noise. A multimedia user 3 can adjust the camera 30, so that the camera can focus in on the multimedia user 3.

In an embodiment, the input image module 4 is a programmable device, such as microprocessor. Although the input image module 4 can be integrally fabricated into a digital camera 30, a further embodiment may allow a solitary construction of the input image module 4, separate from camera 30 and image sensor 2, and connected by wires.

The input image module 4 has a memory component 5, which stores incoming image frames captured by the camera 30 and signaled by the image sensor 2. The stored images are collected and stored for processing between the face detection module 10 and the gesture recognition module 20. The media control interface 6 is yet another component of the input image module, preferably provided in a unitary construction. However, it is possible that the media control interface 6 be provided as an external component to the input image module 4.

The input image module 4 contains modules 10, 20 whose logical function and connectivity is pre-programmed according to algorithms associated with the face detection and gesture recognition. Both the face detection and gesture recognition modules 10, 20 are integrally constructed with input image module 4 in an embodiment of the invention. Depending on results determined by the face detection and gesture recognition modules 10, algorithms, the input image module 4 will provide commands to a multi-media outlet device 8 through the media control interface 6, as illustrated in FIG. 1.

In an embodiment, commands are pre-programmed by pre-assigned gesture directives. The gesture recognition module 20 recognizes a number of specific gesture directives as specific commands that are to be carried out by the multimedia outlet device 8. For example, if the user waves his right hand to the right of his face, the gesture recognition module will recognize that gesture as a command to turn the multimedia outlet device 8 off. However, the system 1 would be capable, in other embodiments, to allow a user 3 to program their own specific gestures as issued commands. For instance, the user could program the system 1 so that the off command is triggered by the user waving his left hand to the left of his face as the off command.

The multimedia control system 1, according the present invention and illustrated in FIG. 1, provides a user 3 a method to control media with face detection and hot spot motion detection. The purpose of the invention is to allow a user 3 to control a multi-media outlet device 8 in a robust way, solely using human gestures. The gestures are captured through a camera 30 and image sensor 2. However, the gesture will only be recognized if the gesture is performed in a pre-assigned motion area (hot spot), which is defined and extracted by algorithms performed by the face detection module 10. The gesture recognition module 20 performs algorithms in order to robustly determine if the movement performed by a user is an actual issued command. If the gesture recognition module 20 determines that the movement is an intended command, it will further determine which command it is, based on a dictionary of gestures pre-assigned in the memory 5.

As stated above, each image hot spot area 12a, 12b is defined by a face area 11, where a first image (hot spot) motion area 12a is assigned to an area just left of the face area 11, and a second image (hot spot) motion area 12b to an area just right of the face area 11. In the embodiment shown, the dimensions of either image motion areas 12a, 12b will depend on the size of the face area f₁. The face area f₁ is defined by an area substantially above the top of the head, and an area substantially below a detected face. In the embodiment shown, the sizes of face area f₁ and image motion (hot spot) areas 12a, 12b can be calibrated to a smaller or larger dimension to better refine the recognition of human gesture directives 14.

As illustrated in FIG. 2, the camera 30 captures images in a field of view 31. A current captured image Cᵢ is electronically signaled, using the image sensor 2, to the input image module 4 in order to be processed by the face detection module 10. The face detection module 10 determines faces in the field of view 31, assigning face areas, starting with f₁. Based on this face area f₁, the face detection module further extracts and assigns hot spot areas 12a, 12b to refine recognition of gesture directives 14. It is also possible to have the face detection module extract and assign only one (hot spot) motion area 12a. In such a situation, a single (hot spot) motion area 12a is used to filter out unwanted motions with even more improved robustness.

In the embodiment shown, each hot spot area 12a, 12b is defined by a face area 11, where a first (hot spot) motion area 12a is assigned to an area just left of the face area f₁ and a second (hot spot) motion area 12b to an area just right of the face area f₁. In the embodiment shown, the dimensions of either (hot spot) motion area 12a, 12b will depend on the size of the face area f₁. The face area f₁ is defined by an area substantially above the top of the head, and an area substantially below a detected face. In the embodiment shown, the sizes of face area f₁ and (hot spot) motion areas 12a, 12b can be calibrated to a smaller or larger dimension to better refine the recognition of human gesture directives 14.

The position of an assigned (hot spot) motion area 12a, 112b may be flexible, as long as they are close to the detected face area f₁, and the captured image Cᵢ in the (hot spot) motion area 12a, 12b can be easily identified. For example, an assigned (hot spot) motion area 12a, 12b area just below the head is not a good candidate, since the body image will interfere with the hand image in that area.

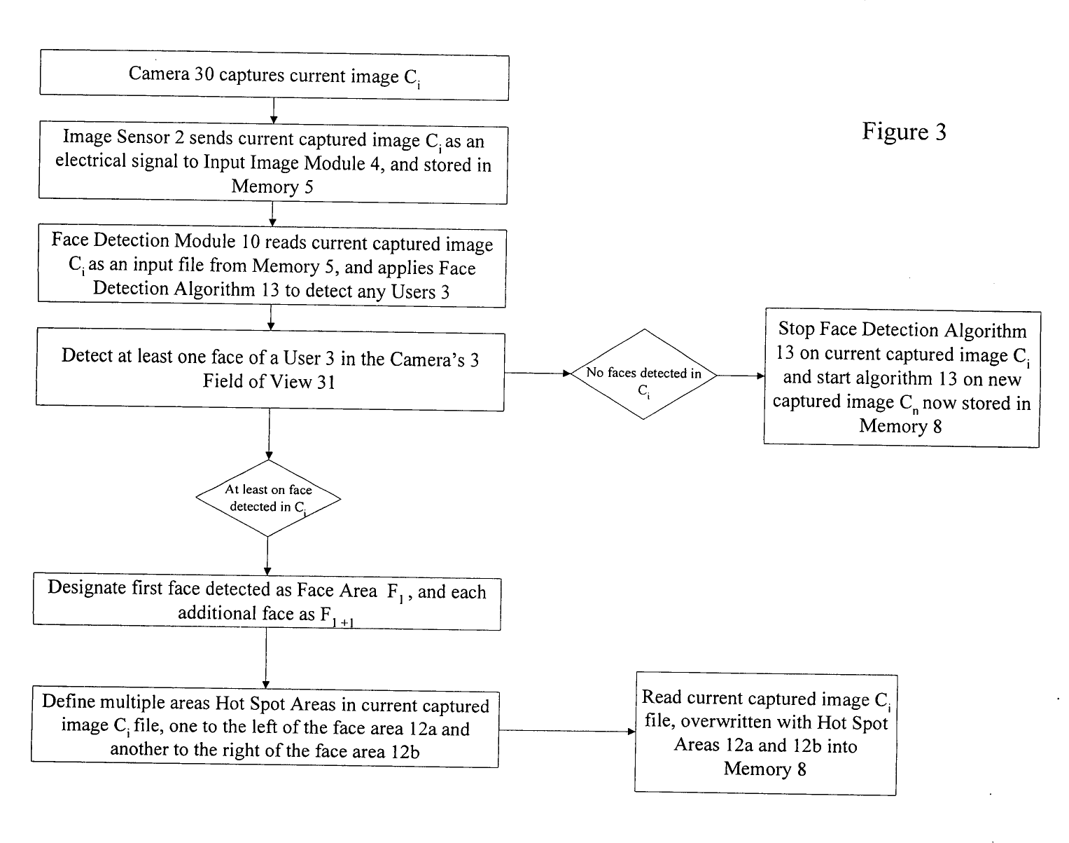

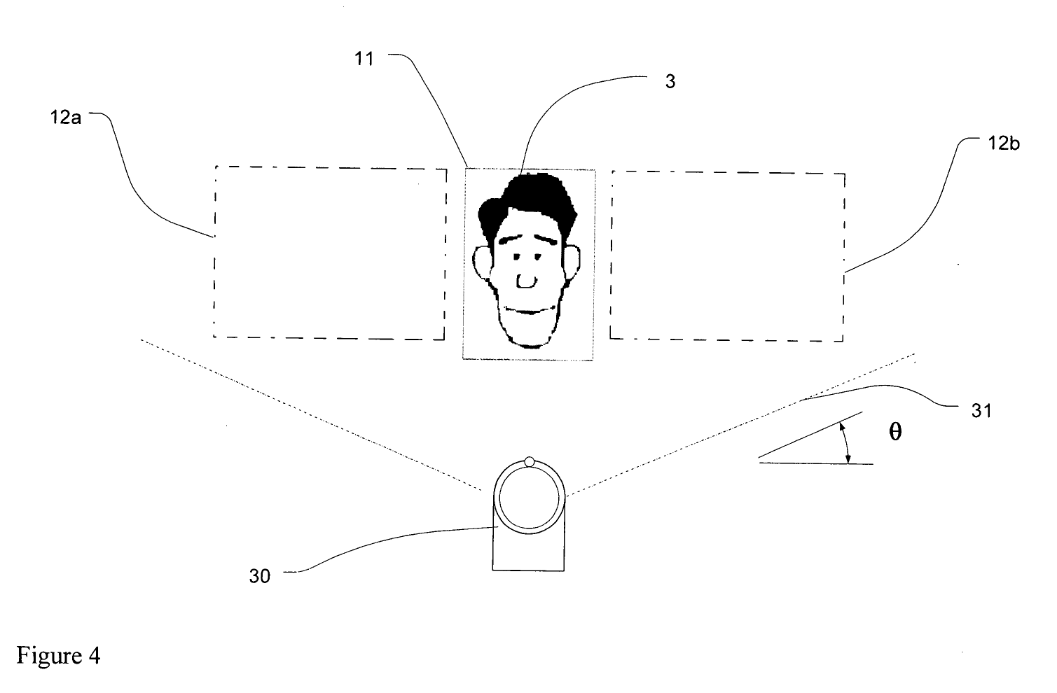

FIG. 3 is a flow diagram of an image hot spot extraction method using face detection, while FIG. 4 illustrates a visual representation of the face detection method. First, the camera 30 captures a current captured image Cᵢ, which is converted to an electrical signal by the image sensor 2. The signal is stored as a file in the memory 5 so that it can be first processed by the face detection module 10.

The face detection module 10 runs a face detection algorithm 13 using the current image Cᵢ. The face detection algorithm 13 processes the current captured image file Cᵢ, detecting any faces in the field of view 31. The face detection algorithm 13 is capable of detecting a number of faces, as stated above, and assigning face area's (f₁, f₂, . . . fₙ).

Initially, the face detection algorithm 13 takes the current image Cᵢ from the memory 5, as an input file. The first face detected will be designated as a face area f₁ Depending on the number of faces within the field of view 31, the algorithm will identify other face areas, designating the second face area as f₂ . . . fₙ, where n represents the number of faces in the field of view 31. If the algorithm detects no faces, the face detection module 10 will return to the memory 5 and repeat the face detection algorithm 13 operation with a new captured image Cn.

After a face is identified, the face detection module 10 will identify and designate the face's left area and right area as (hot spot) motion areas 12a, 12b, respectively. The (hot spot) motion areas 12a, 12b are utilized as masks, to filter out unintentional gesture directives in non-hotspot areas. Once the (hot spot) motion areas 12a, 12b are assigned, the module will produce an output file. The output file consists of an array of rectangles, which corresponds to face area f₁ and the (hot spot) motion areas 12a, 12b, being scaled by the dimension of the face area f₁ detected. The output file is now stored back in the memory 5, so that it can be further processed by the gesture recognition module 20.

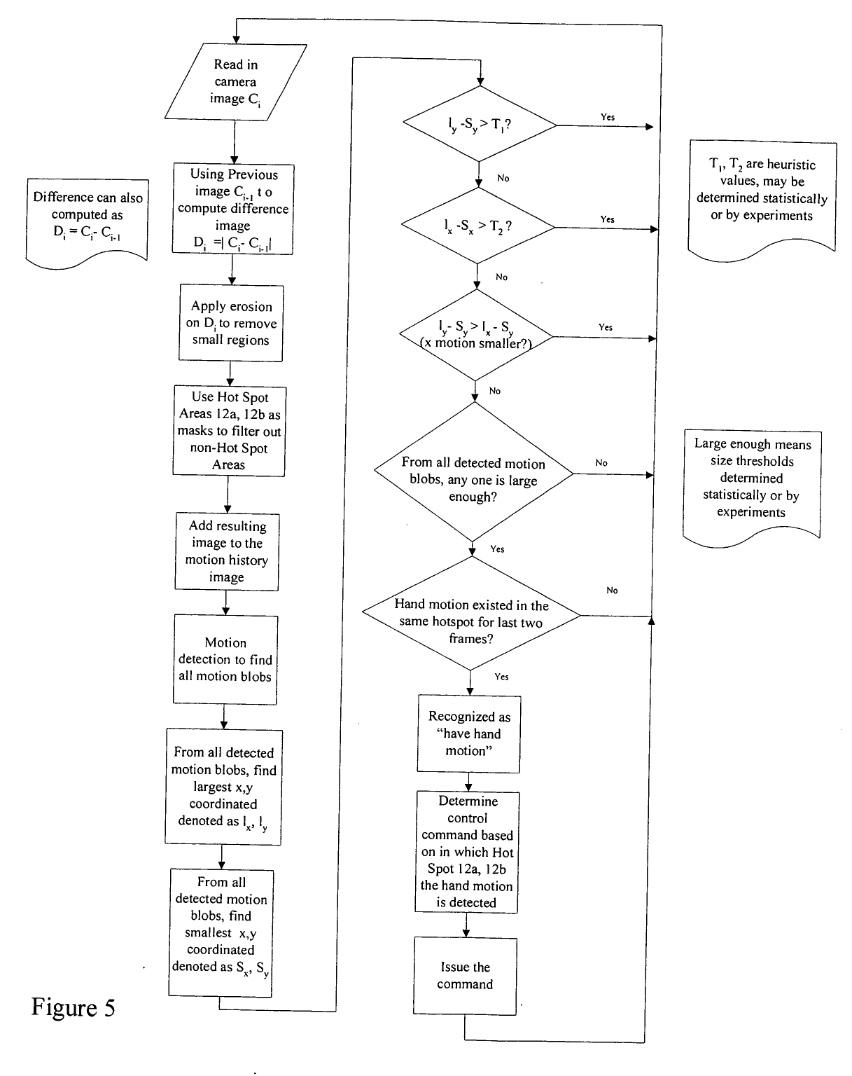

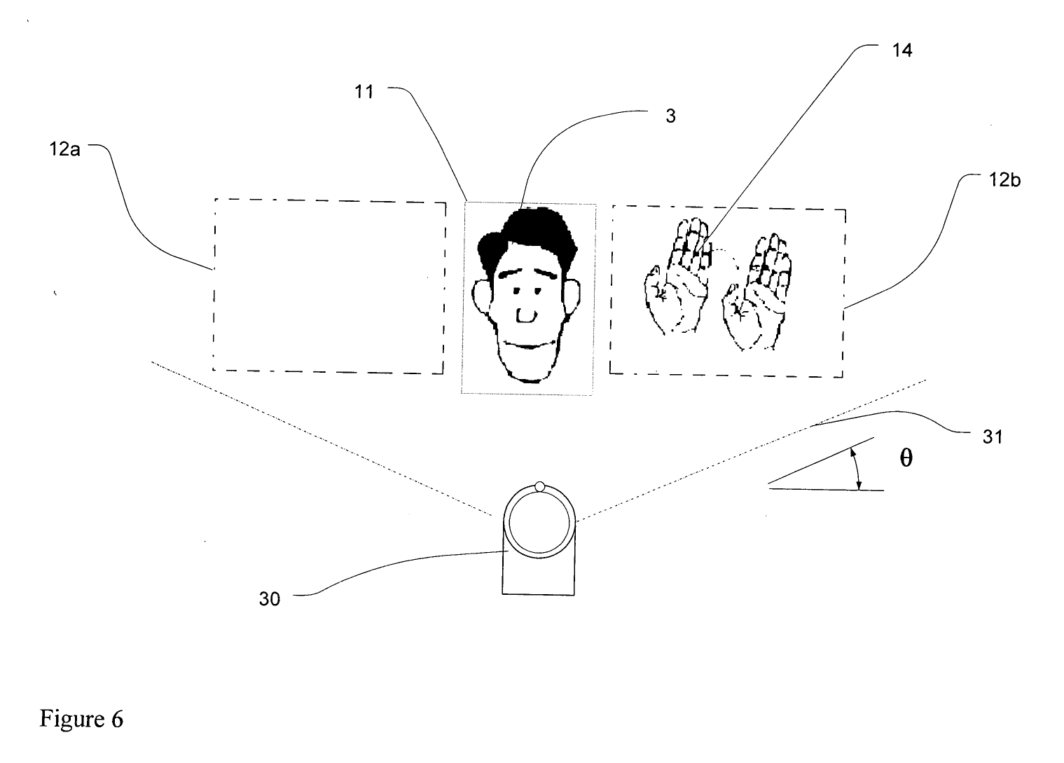

FIG. 5 is a flow diagram, representing media directive for controlling media using gesture recognition, while FIG. 6 illustrates a visual representation of the gesture recognition and media controlled directive.

After the current captured image Cᵢ file is read back into memory 5 from the face detection module 10, the gesture recognition module 20 then runs a gesture recognition algorithm 21.

Using a previous captured image file Cᵢ₋₁, also stored in memory 5, the gesture recognition algorithm 21 first calculates the absolute value of a difference Dᵢ between the current captured image Cᵢ and the previous captured image Cᵢ₋₁. The gesture recognition algorithm 21 also applies an erosion operation to the difference D, to first remove small areas, assisting a more refined recognition of a human gesture directive 14.

In the embodiment shown, a function cvErode is used to perform erosion on the D. The cvErode function uses a specified structuring element that determines the shape of a pixel neighborhood over which the minimum is taken. Although the erosion function is only applied once in the embodiment shown, the erosion function can be applied several times to Dᵢ in other embodiments.

Since the captured images Cᵢ and Cᵢ₋₁ were previously processed by the face detection module 10, and stored in the memory 5, each captured image Cᵢ and Cᵢ₋₁ contains assigned, extracted (hot spot) motion areas 12a, 12b. The gesture recognition algorithm 21 uses the extracted hot spot areas 12a, 12b to mask and filter movement in non-hot spot regions. As a result, the gesture recognition algorithm 21 modifies Dᵢ with respect to motion in the non-designated hot spot areas, building a motion history image (MHI). The motion history image (MHI) is used to detect motion blobs, and further operations of the gesture recognition algorithm 21 determine if these gesture blobs are actual human gesture directives 14

The motion history image (MHI) quantifies and qualifies movement over time, representing how the motion took place during image sequence. In the present invention, motion blobs are reviewed and recognized by the gesture recognition module 20 in specific areas, particularly the (hot spot) motion areas 12a, 12b.

Each motion history image (MHI) has pixels, identified and defined by specific coordinates x, y of timestamp. The coordinates relate to a latest motion in that pixel. As movement is detected in the (hot spot) motion areas 12a, 12b, the gesture recognition algorithm 21 revises the motion history image (MHI) to create a layered history of the resulting motion blobs.

For all of the motion blobs detected in the (hot spot) motion areas 12a, 12b, the gesture recognition algorithm 21 locates the largest and smallest x,y pixel coordinates, and denotes the largest value as lₓ, l_{y} and the smallest value as Sₓ, S_{y}.

Using the largest and smallest x,y pixel coordinates, of the motion history image (MHI), the gesture recognition algorithm 21 will first determine if the difference between l_{y} and S_{y} is larger than a first heuristic value T₁ (l_{y}−S_{y}>T₁). If that question is answered yes, then the gesture recognition algorithm 21 will not recognize the current captured image C, as having a recognized gesture directive 14. The first heuristic value T₁ may be determined statistically or by experiments, and implemented into the algorithm before the multimedia control system 1 is installed. If there are no recognized gesture directives 14, then the gesture recognition algorithm 21 will stop processing Cᵢ, and starts over with a new captured image Cₙ, which has been first processed by the face detection module 10.

If the difference between l_{y} and S_{y} is not larger than the first heuristic value T₁, then the gesture recognition algorithm 21 will move to the next step, and determine if the difference between lₓ and Sₓ is larger than a second heuristic value T₂ (lₓ−Sₓ>T₂). If so, then the gesture recognition algorithm 21 will not recognize the current captured image C, as having a recognized human gesture directive 14, starting over with a new captured image Cₙ. Otherwise, the gesture recognition algorithm 21 will determine if the x motion (lₓ−S_{y}) is smaller than the y motion (l_{y}−S_{y}). If the x motion is smaller than y motion, then the gesture recognition algorithm 21 will not recognize a gesture directive 14 in the current captured image Cᵢ, again the algorithm 21 will start over with a new captured image Cₙ.

As a default, if the gesture recognition algorithm 21 has yet to identify and recognize a gesture directive 14 in the current captured image Ci, but there is some “big enough” components in the motion history image (MHI), then the gesture recognition algorithm 21 will determine there is a “have hand motion.” “Big enough” would be a heuristic threshold determined statistically or through experiments, prior to implementation of the system 1.

If there are three continuous captured images having recognized “have hand motions”, then the gesture recognition module 10 will issue a specific command to the multimedia outlet device, through the media control interface 6.

The “have hand motion” should be a gesture directive 14 that controls a specific command to the multimedia outlet device 8. The specific control command that relates to the “have hand motion” is determined on where the “have hand motion” is recognized, either the left (hot spot) motion area 12a or the right (hot spot) motion area 12b. As discussed above, the specific control command is either pre-assigned to a specific (hot spot) motion area 12a, 12b, or can be programmed by the user 3.

The gesture recognition module 20 sends a specific command if the “have hand motion” is recognized over three continuous captured images. That specific command is then sent to media control interface 6 that relays a corresponding electrical command signal to the multimedia outlet device 8.

All gesture directives for deferent gestures will be well-defined, pre-assigned commands stored in the multimedia control system 1. However, it is possible that the user 3 can define his own commands prior to use. Therefore, if a hand wave in the right (hot spot) motion area 12b is a defined gesture to turn-on the multimedia outlet device 8, and the gesture recognition algorithm 21 recognizes the hand wave as a gesture directive 14 in the right (hot spot) motion area 12b, then the multimedia outlet device 8 will be signaled to turn-on. Conversely, if a hand wave in the left (hot spot) motion area 12a is a defined gesture to turn-off the multimedia outlet device 8, and the gesture recognition algorithm 21 recognizes the hand wave in the left (hot spot) motion area 12a as a gesture directive 14, then the multimedia outlet device 8 will be signaled to turn-off.

There are two implementations when the motion history image (MHI) is built, in order to perform motion detection. In one implementation, the motion history image (MHI) is built using the whole captured image Cᵢ. However, in the another implementation, the motion history image (MHI) is built using only the (hot spot) motion area 12a, 12b image. Either implementation will lead to same results when the user 3 is stationary, i.e. little or no head motion. However, if the user 3 is moving, these implementations are different.

In the embodiment shown, the assigned (hot spot) motion areas 12a, 12b are relative to the face f₁, and the face f₁ may be moving somewhat. Although the motion detection may be accurate in these cases, it is possible that the movement by the head will cause errors in motion detection. If the motion history image (MHI) is built using whole image, there maybe be motion in an assigned (hot spot) motion area 12a, 12b. However, if the motion history image (MHI) is built only using assigned (hot spot) motion area 12a, 12b, then it is possible to refine detection because external motion is filtered out.

Additionally, in an embodiment, where only one (hot spot) motion area 12a is assigned, a more powerful gesture recognition algorithm is needed to recognize gestures in the hotspot to achieve higher accuracy, including a motion history image (MHI) that is built from only assigned (hot spot) motion areas 12a, 12b.

The apparatus and methods described above can be used to control any interactive multimedia outlet device 8, such that face detection technology helps define and extract (hot spot) motion areas 12a, 12b that limit recognition of motion to those (hot spot) motion areas 12a, 12b, issuing command controls through human gestures to outlet device in a very robust way.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

1. A method of controlling a multimedia device, wherein the method comprises the steps:
determining motion areas in an image using face detection;
detecting motion in at least one motion area;
determining if the motion matches a pre-assigned command;
providing a signal to the multimedia device corresponding to a pre-assigned command.

2. The method of claim 1, wherein the motion detection and command determination further comprises a step of extracting image motion areas using a current captured image (Ci).

3. The method of claim 2, further comprising a step of calculating and analyzing a difference (Dᵢ) between the current captured image (Cᵢ) and a previous captured image (Cᵢ₋₁), using the current captured image (Cᵢ).

4. The method of claim 3, further comprising a step of applying an erosion on the difference (Dᵢ) to remove small areas.

5. The method of claim 4, further comprising a step of applying the image motion area as a mask to filter out non-motion areas.

6. The method of claim 5, further comprising a step of adding the difference (Dᵢ) to build a motion image.

7. The method of claim 6, wherein the motion image is built from the captured image.

8. The method of claim 6, wherein the motion image is built from the motion area.

9. The method of claim 6, further comprising a step of finding largest x, y and smallest x, y coordinates of each detected motion area, and denoting each as lx, ly, sx and sy.

10. The method of claim 2, further comprising the step of taking the current captured image (Cᵢ) using a camera.

11. The method of claim 10, further comprising the step of detecting faces in the current captured image (Cᵢ) and denoting each face as F1, F2, F3, . . . Fn.

12. The method of claim 11, wherein the motion area is defined by a left and right area proximate each face.

13. The method of claim 12, further comprising the step of defining a command for a gesture over a left motion area and a command for a gesture over a right motion area.

14. A media control apparatus comprising:
a camera having an image sensor;
an input image module that receives picture images through the image sensor;
a memory connected to the input image module;
a face detection module connected to the input image module;
a command recognition module connected to the input image module; and
a media control interface that receives commands from the input image module and converts the commands into electrical signals controlling a multimedia outlet device.

15. The media control apparatus of claim 14, wherein the image sensor is integral with the camera.

16. The media control apparatus of claim 14, wherein the input image module is integral with the camera.

17. The media control apparatus of claim 14, wherein the input image module is a microprocessor.

18. The media control apparatus of claim 14, wherein the memory, the face detection module, and the gesture recognition module are integral with the input image module.

19. The media control apparatus of claim 14, wherein the media control interface is integral with the input image module.

20. The media control apparatus of claim 14,
wherein the camera, image sensor, input image module, memory, face detection module, gesture recognition module, and media control interface are integrally constructed as one component; and
the media control apparatus is an external component connected to the multimedia outlet device.
